(19) United States
(12) Patent Application Publication
(10) Pub. No.: US 2008/0008077 A1
(43) Pub. Date: Jan. 10, 2008

(54) OPTICAL DISK DRIVE AND FOCUS OFFSET CONTROL METHOD

(76) Inventor: Shigetoshi HIRAI, Hiratsuka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/668,858

(22) Filed: Jan. 30, 2007

(30) Foreign Application Priority Data
Jan. 31, 2006 (JP) 2006-022531

(51) Int. Cl. G11B 7/00

(52) U.S. Cl. 369/112.01

(57) ABSTRACT

An optical disk drive includes an optical pickup which emits a light beam onto an optical disk, and receiving a reflection light to output a signal in accordance with the reflection light, a PRML processing unit which carries out signal processing with respect to the signal output from the optical pickup using a partial response and maximum likelihood (PRML) technique, a focus offset setting unit which sets a focus offset value used for focusing the optical pickup based on a difference value between a signal processed by the PRML processing unit and the signal output from the optical pickup, and a focus control unit which controls a focus of the optical pickup in accordance with focus offset set by the focus offset setting unit.

### CROSS-REFERENCE TO RELATED APPLICATIONS

This application is based upon and claims the benefit of priority from prior Japanese Patent Application No. 2006-022531, filed Jan. 31, 2006, the entire contents of which are incorporated herein by reference.

### BACKGROUND OF THE INVENTION

1. Field of the Invention

The present invention relates to an optical disk drive, which reads (regenerates) a signal recorded to an optical disk using a partial response and maximum likelihood (PRML) technique. Moreover, the present invention relates to a focus offset control method used for the optical disk drive.

2. Description of the Related Art

An optical disk drive controls focus offset so that the amplitude of a read signal (RF signal) becomes maximum to focus a beam spot from an optical pickup on a track of an optical disk in an optimum state. The processing of controlling the focus offset is hereinafter referred to as a focus offset control procedure. Thus, even if there is the difference in the configuration of lens and optical pickup, the focus offset is controlled, thereby effectively receiving a reflection light from the optical disk.

However, high recording density of an optical disk is achieved; as a result, the pits on the optical disk are short. Moreover, the interval between pits becomes short, and thereby, the amplitude of the RF signal read from the optical disk attenuates. For this reason, the amplitude of the RF signal does not sensitively react with respect to focus offset control. Therefore, it is difficult to detect the optimum focus offset in which the RF signal becomes the maximum amplitude.

Conventionally, the following apparatus (drive) has been disclosed in JPN. PAT. APPLN. KOKAI Publication No. 2002-319231. The apparatus controls focus offset using a signal after partial response (PR) is made.

The apparatus disclosed in the foregoing Publication converts a read signal detected from an optical disk into digital data. Thereafter, PR is carried out with respect to the digital data to calculate a frequency distribution indicative of the quality of the PR signal. Then, a dispersion value is calculated from the frequency distribution. The apparatus controls focus according to a focus offset value when the dispersion value becomes the minimum.

Moreover, an optical disk drive controlling focus offset using a PRML technique has been disclosed in JPN. PAT. APPLN. KOKAI Publication No. 2004-152445.

The optical disk drive disclosed in the foregoing Publication is provided with an adaptive equalizer, which is adaptively controlled using a signal decoded by the PRML technique. The drive determines a servo offset optimal point using the control result of the adaptive equalizer to change a servo offset setup value. If the focus offset shifts from the optimal point, beam power (strength) distribution is distorted on an information recoding surface of the optical disk. As a result, the beam power distribution diverges. The beam power distribution diverges, and thereby, a high frequency component of the read signal is reduced. For this reason, the adaptive equalizer is controlled to have equalizer characteristics of restoring the lost high frequency component resulting from the matter that is focus offset shifts from the optical point.

As described above, the apparatus disclosed in the foregoing Publication No. 2002-319231 calculates frequency distribution and dispersion value using the PR signal. In other words, control is carried out using numerical statistics. For this reason, hardware or software is required to take a relatively complicated statistical procedure. As a result, it is difficult to simplify the device configuration.

Moreover, the drive disclosed in the foregoing Publication No. 2004-152445 is provided with the adaptive equalizer, which is adaptively controlled using a signal decoded by the PRML technique, as described above. The servo offset optimal point must be calculated using the control result of the adaptive equalizer. In this case, a focus offset optimal point is determined using equalization coefficient of the adaptive equalizer. For this reason, a relatively complicated procedure is required.

### BRIEF SUMMARY OF THE INVENTION

In accordance with a aspect of the invention, there is an optical disk drive comprising:

an optical pickup which emits a light beam onto an optical disk, and receiving a reflection light to output a signal in accordance with the reflection light;

a PRML processing unit which carries out signal processing with respect to the signal output from the optical pickup using a partial response and maximum likelihood (PRML) technique;

a focus offset setting unit which sets a focus offset value used for focusing the optical pickup based on a difference value between a signal processed by the PRML processing unit and the signal output from the optical pickup; and

a focus control unit which controls a focus of the optical pickup in accordance with focus offset set by the focus offset setting unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an optical disk drive according to an embodiment of the present invention;

FIG. 2 is a view to showing the detailed configuration of an equalization error generator circuit in a signal processor 14 in this embodiment;

FIG. 3 is a graph to explain the relationship between an equalization error value to a focus offset value and RF amplitude;

FIG. 4 is a flowchart to explain a focus offset (FOF) control procedure according to a first embodiment;

FIG. 5 is a table to explain an equalization error list 19a for storing association of an equalization error value with a focus offset value;

FIG. 6 is a flowchart to explain a focus offset (FOF) control procedure according to a second embodiment;

FIG. 7 is a flowchart to explain a focus offset (FOF) control procedure according to a third embodiment;

FIG. 8 is a flowchart to explain a focus offset (FOF) control procedure according to a fourth embodiment;

FIG. 9 is a graph to explain the relationship between an equalization error value to a focus offset value and symmetry;

FIG. 10 is a flowchart to explain a recording procedure using the focus offset control procedure of this embodiment;

FIG. 11 is a view to explain a recording procedure; and

FIG. 12 is a flowchart to explain a focus offset (FOF) control procedure according to a fifth embodiment.

### DETAILED DESCRIPTION OF THE INVENTION

Embodiments of the present invention will be described below with reference to the accompanying drawings.

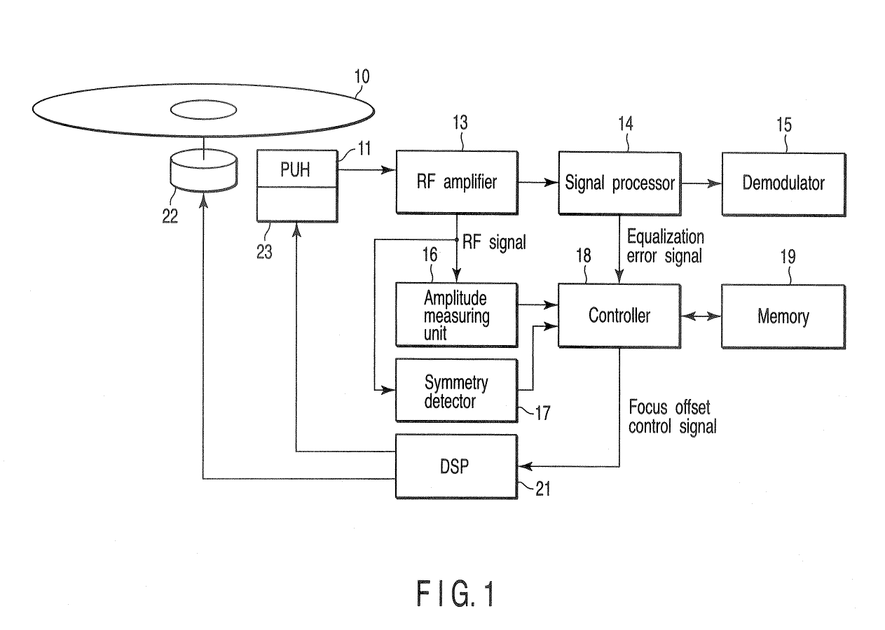

FIG. 1 is a block diagram showing the configuration of an optical disk drive according to an embodiment of the present invention.

An optical disk 10 used as a recording medium has a surface formed with a spiral track, and is rotatably driven via a spindle motor 22. Information is recorded or/and reproduced from the optical disk 10 using a laser beam output from an optical pickup head (PUH) 11.

The PUH 11 includes laser diode, collimator lens, beam splitter, objective lens, cylindrical lens, photodetector, lens position sensor, etc.

The laser diode outputs a laser beam via drive control by a laser controller (not shown). The laser beam output from the laser diode is emitted onto the optical disk 10 via the foregoing collimator lens, beam splitter and objective lens. Reflection light from the optical disk 10 is guided into a photodetector via the foregoing objective lens, beam splitter and cylindrical lens. The photodetector comprises a four-divided photodetection cell, for example, and outputs a detection signal of the photodetection cell to an RF amplifier 13.

The RF amplifier 13 amplifies a signal from the PUH 11, and then, outputs and generates the following signals. Specifically, one is a tracking error signal indicating an error in the center of a beam spot of laser beam and the center of track. Another is a focus error signal indicating an error from a just focus; for example, a full addition signal (RF signal) adding signals output from the four-divided photodetection cell of the PUH 11. The RF signal generated by the RF amplifier 13 is output to signal processor 14, amplitude measuring unit and symmetry detector 17.

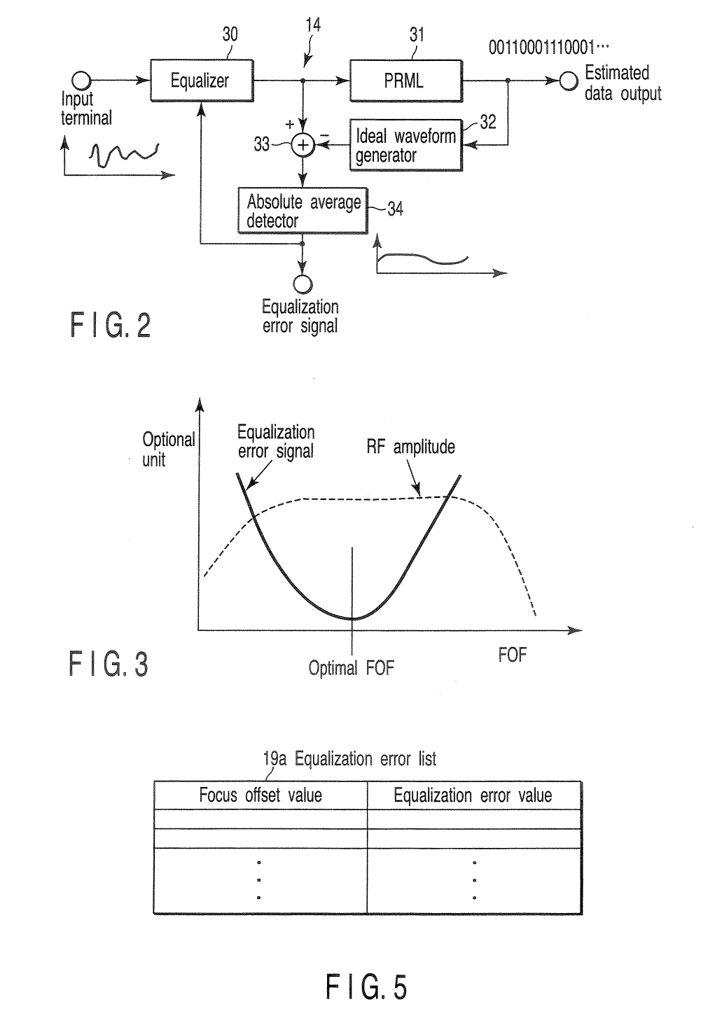

The signal processor 14 has a function of carrying out various processing with respect to the signal output from the RF amplifier 13. The function of the signal processor 14 includes a function of processing the RF signal output from the RF amplifier 13 using a partial response and maximum likelihood PRML technique to output a read signal. Moreover, the signal processor 14 is provided with an equalization error generator circuit for controlling a focus offset value using a PRML-processed signal. The equalization error generator circuit outputs a signal (equalization difference value) indicating the difference between the PRML-processed signal and the RF signal output from the RF amplifier 13. The details will be described later (see FIG. 2).

A demodulator 15 demodulates the PRML-processed signal in the signal processor 14, and thereafter, outputs it.

The amplitude measuring unit 16 measures the amplitude of the RF signal output from the RF amplifier 13, and then, outputs the amplitude value to a controller 18.

The symmetry detector 17 detects a symmetry value based on the RF signal output from the RF amplifier 13. Specifically, the symmetry detector 17 top peak value A and bottom peak value B of the RF signal after AC coupling. Using the foregoing values, the symmetry detector 17 detects a symmetry value β from the following equation. In this case, peak values A and B are measured using a level when no signal is given as 0. The symmetry value β detected by the symmetry detector 17 is used for a focus offset control procedure of the fourth embodiment described later.
β=(A+B)/(A−B)

Incidentally, a detector for detecting β and γ values may be provided in place of the foregoing symmetry detector 17. The β and γ values are used for the focus offset control procedure of the fourth embodiment described later in place of the symmetry value β. In other words, recording power value characteristics such as the foregoing symmetry value β, β and γ values are used, and thereby, the same processing is possible in either case. The case of using the symmetry value β based on the configuration of FIG. 1 will be explained below.

Tracking error signal and focus error signal output from the RF amplifier 13 are supplied to spindle motor 22, thread motor (not shown) and servo control circuit (not shown) for controlling a focus drive mechanism 23.

The servo control circuit executes the following focus servo control. According to the focus servo control, the focus drive mechanism 23 is driven using a digital signal processor (DSP) 21 in accordance with a focus error signal. A laser beam output from the PUH 11 is just focused on a recording film of the optical disk 10.

Moreover, the servo control circuit executes the following tracking servo control. According to the tracking servo control, a tracking actuator and/or thread motor is driven using the DSP 21 in accordance with the tracking error signal output from the RF amplifier 13. The laser beam output from the PUH 11 is always traced on a track formed on the optical disk 10.

The DSP 21 drives spindle motor 22, thread motor and focus drive mechanism 23 under the control by the servo control circuit. In this case, the spindle motor 22 rotates the optical disk 10, and the thread motor moves the PUH 11 to the radius direction (tracking direction). The focus drive mechanism 23 moves the objective lens of the PUH 11 to a focusing direction (optical axis direction of lens) and a tracking direction (radius direction of optical disk).

The controller 18 comprehensively controls the whole of the drive using a RAM in a memory 19 as a work area. The controller 18 further controls various devices according to programs recorded to a ROM in the memory 19. The controller 18 executes a focus offset control program stored in the memory 19. By doing so, the controller 18 carries out focus offset control (focus offset control procedure) using the equalization error difference value output from the signal processor 14. When taking the focus offset control procedure, the controller 18 updates the focus offset value by a predetermined offset. Simultaneously, the controller 18 records an equalization error list to the RAM in the memory 19. The equalization error list associates the focus offset value with an equalization error (difference value) output from the signal processor 14 when the focus offset value is given.

FIG. 2 shows the detailed configuration of an equalization error generator circuit included in the signal processor 14.

As shown in FIG. 2, the equalization error generator circuit includes equalizer 30, PRML processor 31, ideal waveform generator 32, difference detector 33 and absolute average detector 34.

The equalizer 30 inputs a signal output from the PUH 11 via RF amplifier 13 and analog-to-digital converter (not shown). Then, the equalizer 30 removes interference between codes from the RF signal digitized via the analog-to-digital converter to achieve waveform equalization for improving a signal-to-noize ratio.

The PRML processor 31 processes a signal waveform-equalized by the equalizer 30 using the PRML technique. Then, the PRML processor 31 binarizes the signal into the most surely bit string while comparing a read signal with a target signal.

The ideal waveform generator 32 generates an ideal waveform signal based on the signal processed by the PRML processor 31, and then, outputs it.

The difference detector 33 detects a difference value between the signal processed by the PRML processor 31 and the signal waveform-equalized by the equalizer 30. Then, the difference detector 33 outputs a signal indicating the foregoing difference value.

The absolute average detector 34 averages an absolute value of a voltage value of the signal output from the difference detector 33, and then, outputs it. Moreover, the absolute average detector 34 squares and averages the voltage value in addition to the output averaging the absolute value of the voltage value. The signal output from the absolute average detector 34 is referred to as an equalization error signal in the following description.

The equalization error signal is determined in the following manner. Specifically, data sequence having the highest possibility is estimated from an input waveform according the PRML principle. An ideal input waveform is generated from the estimated data sequence to calculate an error of the ideal input waveform and an actual waveform (input waveform). The controller 18 sets a focus offset value based on an equalization error value (difference value) indicated by the equalization error signal output from the absolute average detector 34. The controller 18 further outputs a focus offset control signal for controlling the drive of the focus drive mechanism 23 to the DSP 21.

The relationship between the equalization error value to the focus offset value and the amplitude of the RF signal will be explained with reference to FIG. 3.

High density of the optical disk 10 is achieved, and thereby, the amplitude of the RF signal detected from the optical disk 10 becomes small. For this reason, the amplitude of the RF signal does not sensitively react with respect to a change of the focus offset value. Therefore, as seen from FIG. 3, the amplitude of the RF signal becomes large in a specified range of the focus offset value. If the focus offset value is set in the range where the amplitude of the RF signal becomes large, the optimal focus offset value is not always obtained.

Conversely, the equalization error value has a change larger than the RF signal with respect to a change of the focus offset value. In other words, response sensitivity to the change of the focus offset value is high. Therefore, the focus offset value is calculated based on the equalization error value, and thereby, accurate control to a focus optical point is achieved with a simple configuration.

The focus offset value is set as an ideal focus offset value when the equalization error value is the lowest. In this case, there is no need of always obtaining the ideal focus offset value. In the following description, a focus offset value close to the ideal focus offset value and having accuracy required for the optical disk drive is set. The focus offset value close to the ideal focus offset value is set as an optimal focus offset value.

A focus offset control procedure used for the optical disk drive according to an embodiment of the present invention will be explained below.

### First Embodiment

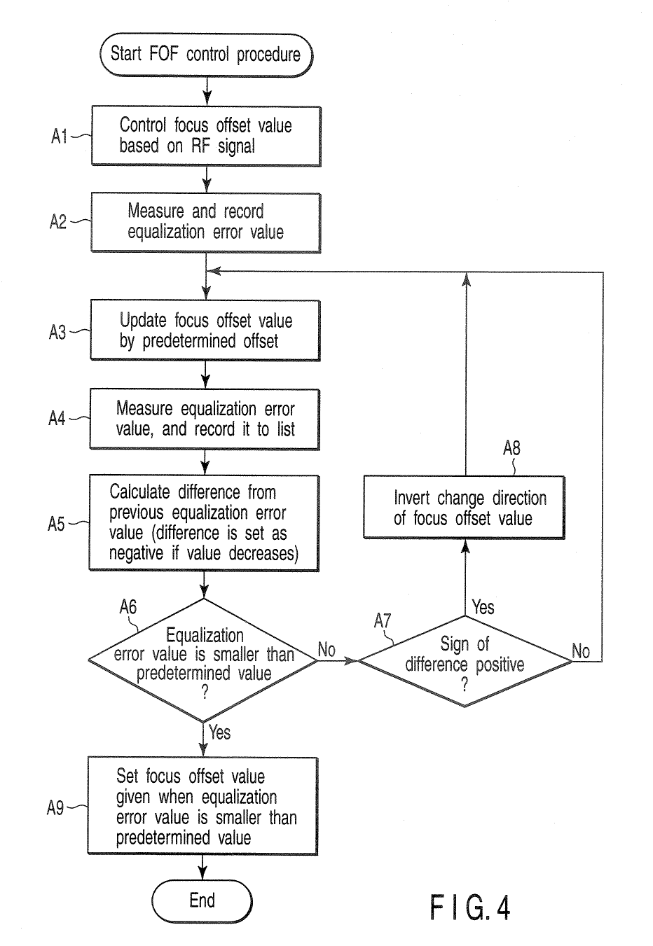

A focus offset (FOF) control procedure according to a first embodiment will be explained below with reference to a flowchart shown in FIG. 4.

The focus offset control procedure of the first embodiment is taken via the following steps. Specifically, a focus offset value is changed by a predetermined offset in any direction of increase or decrease. Then, the decreasing direction of the difference between the focus offset value and a value before equalization error value is determined. A focus offset value having an error absolute value smaller than a predetermined value in the decreasing direction is determined.

First, the controller 18 controls a focus offset value based on the RF signal output from the RF amplifier 13 (step A1).

For example, the controller 18 carries out focus servo and tracking servo controls using a servo control circuit (not shown) until the amplitude value of the RF signal measured by the amplitude measuring unit 16 exceed a predetermined value. If the amplitude value of the RF signal measured by the amplitude measuring unit 16 becomes larger than the predetermined value, the controller 18 sets the focus offset value given at that time. Incidentally, the predetermined value for determining the amplitude of the RF signal is set to a value when a signal having the amplitude required for generating the equalization error signal is obtained in the signal processor 14.

For example, the controller 18 sets an upper or lower limit focus offset value in a preset range so that an optimal focus offset value is securely included. In this case, the RF signal does not always have the amplitude required for generating the equalization error signal in the signal processor 14. Moreover, in order to shorten processing time described later, the preset range is preferably set narrower so that an optimal focus offset value is securely included.

The controller 18 outputs a focus offset control signal to the DSP 21 in accordance with the focus offset value controlled based on the RF signal. The DSP 21 controls a focus in a manner of adding focus offset corresponding to the focus offset control signal from the controller 18, and driving the focus drive mechanism 23.

The signal processor 14 generates an equalization error signal with respect to the RF signal output from the RF amplifier 13 using the equalization error generator circuit, and then, outputs it to the controller 18. The controller 18 associates an equalization error value indicating the equalization error signal from the signal processor 14 with the preset focus offset value at that time, and then, records it to the memory 19 (step A2).

FIG. 5 shows an equalization error list 19a for storing the association of an equalization error value with a focus offset value. The equalization error list 19a is stored with data given below. Specifically, a focus offset value and an equalization error value detected by the signal processor 14 when focus is controlled using the focus offset value are successively associated and stored.

The controller 18 updates the initial focus offset value set in step A1 to any direction of increase or decrease by a predetermined offset. Simultaneously, the controller 18 records each equalization error value detected when focus is controlled based on each focus offset value thus updated to the equalization error list 19a.

For example, the controller 18 increases the focus offset value by a predetermined offset (step A3). When updating the focus offset value, the controller 18 associates the equalization error value indicating the equalization error signal from the signal processor 14 with the focus offset value. Then, the controller 18 store the foregoing correspondence to the equalization error list 19a (step A4).

Incidentally, the following value is preset as a predetermined value for updating the focus offset value. That is, the value has a resolution capable of determining an optimal focus offset value based on the equalization error value. In this case, the foregoing predetermined value is set smaller, and thereby, the optimal focus offset value is accurately obtained; however, processing time becomes long. Therefore, the predetermined value (resolution) is determined to satisfy the following requirement (determined in the same manner in the following second to fifth embodiments). According to the requirements, an optimal focus offset value is detected with an accuracy required for the optical disk drive without spending the processing time more than the necessity.

When recording the equalization error value to the equalization error list 19a, the controller 18 calculates the difference between the preceding value and the equalization error value previously recorded to the equalization error list 19a (step A5). In this case, if the equalization error value decreases, a sign of the difference of the equalization error value is set as negative (minus).

The controller 18 determines whether or not the equalization error value is smaller than a predetermined value (hereinafter, referred to as error determination value) (step A6).

As described in FIG. 3, the focus offset value is set as an ideal focus offset value when the equalization error value is the lowest. The error determination value is set to a value capable of determining an optimal focus offset value close to the ideal focus offset value. In other words, the lowest value of the equalization error value is not always determined so long as an equalization error value corresponding to a focus offset value having accuracy required for the optical disk drive.

If the equalization error value is not smaller than the error determination value (NO in step A6), the controller 18 determines whether or not a sign of the difference is positive (plus).

If the sign of the difference is not positive (NO in step A7), the controller 18 return to step A3. Thereafter, the controller 18 updates the focus offset value by a predetermined offset (step A3), and then, executes the foregoing same procedures (steps A4 to A7). In other words, if the equalization error value decreases with the update on the focus offset value, this means that the focus offset value is updated to closes to an optimal focus offset value. Therefore, the controller 18 continuously executes the same procedures.

On the contrary, if the sign of the difference is positive (YES in step A7), the equalization error value increases with the update on the focus offset value. In other words, the focus offset value is updated by a predetermined offset, and thereby, it becomes far from the optima focus offset value. In this case, the controller 18 inverts the direction of updating the focus offset value (step A8). In the foregoing description, update is made to the direction of increasing the focus offset value. Here, the focus offset value is here decreased by a predetermined offset. The focus offset value is updated in the manner described above, and thereby, it closes to the optimal focus offset value.

The controller 18 returns to step A3. Thereafter, the controller 18 updates the focus offset value by a predetermined offset (step A3), and then, executes the foregoing same procedures (steps A4 to A7).

As a result, if it is determined that the equalization error value is smaller than the error predetermination value (YES in step A6), the controller 18 takes the following procedure. Specifically, the controller 18 sets the focus offset value when it is determined that the equalization error value is smaller than the error predetermination value as a focus offset value used for focus control (step A9). Then, the controller 18 ends the focus offset control procedure.

The controller 18 outputs a focus offset control signal corresponding to the focus offset value set via the focus offset control procedure to the DSP 21 to control the focus with respect to the PUH 11.

According to the focus offset control procedure of the first embodiment, the focus offset value is updated by predetermined offset in any direction of increase or decrease. Simultaneously, the optimal focus offset value is calculated based on the equalization error value output from the signal processor 14. By doing so, accurate control to a focus optimal point is achieved using a read function of the PRML technique with a simple configuration. In this case, if the equalization error value changes to a preferable direction by update on the focus offset value, that is, decreases, the focus offset value is updated in the foregoing direction. On the other hand, if the equalization error value changes to a unpreferable direction, that is, decreases, the direction of updating the focus offset value is inverted so that the equalization error value changes to a preferable direction. According to the first embodiment, even if predetermined offset is increased or decreased from the initially set focus offset value, the optimal focus offset value is settable. Moreover, the optimal focus offset value is set using only equalization error value having high sensitivity to a change of the focus offset value. Therefore, this serves to reduce a possibility of making a setting mistake.

In the procedure of the first embodiment, there is a possibility that the following case is given. That is, the equalization error value is measured gain and again; nevertheless, it does not become smaller than the predetermined value. Thus, a procedure given below is also taken considering the foregoing case. Specifically, time spent for taking the procedure of FIG. 4 is measured, and the procedure forcedly ends if the procedure (focus offset setup) does not finish within a predetermined time. Moreover, an opportunity of taking the step A8 is counted, and the procedure is forcedly stopped if the opportunity becomes more than a predetermined count (e.g., two times). A focus offset value having the smallest equalization error is selected from a measured list after the procedure stops, and given as the final setup value.

In the foregoing first embodiment, the predetermined value used for updating the focus offset value in step A3 is constant. In this case, the predetermined value may be changed during the procedure. For example, an update value is set relatively larger in the first stage of the procedure. If the difference value of the equalization error value calculated in step AS becomes a predetermined reference value, the update value is set small. The update value may be changed in several stages. Thus, the predetermined value used for updating the focus offset value is stepwise changed. By doing so, the optimal focus offset value is detected with accuracy required for the optical disk drive without making long the processing time more than the necessity.

### Second Embodiment

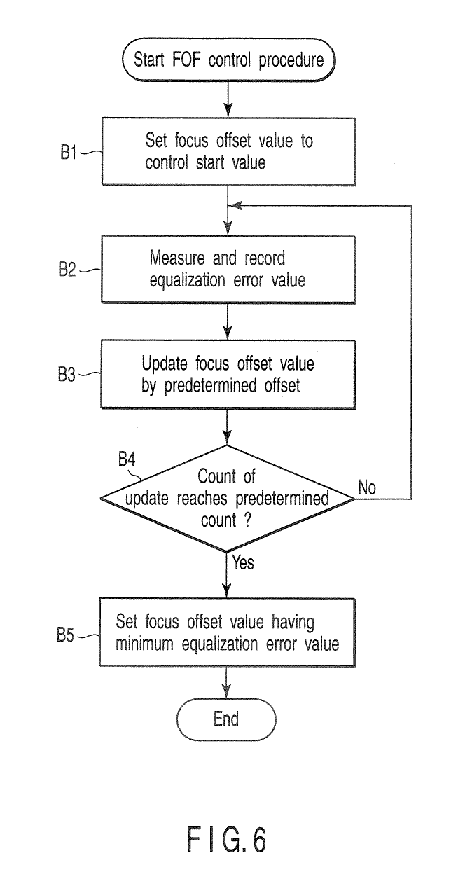

A focus offset (FOF) control procedure according to a second embodiment will be explained below with reference to a flowchart shown in FIG. 6.

The focus offset control procedure of the second embodiment is taken via the following steps. Specifically, a focus offset value is changed from the initial value by predetermined offset and by predetermined counts to detect an equalization error value given when each focus offset value is set. An equalization error value having the maximum equalization error value is selected from these values, and set as a focus offset value.

First the controller 18 sets the focus offset value to a control start value (initial value) (step B1).

For example, the controller 18 sets an upper or lower limit focus offset value n a preset range so that an optimal focus offset value is securely included. In this case, in order to shorten processing time described later, the preset range is preferably set narrower so that an optimal focus offset value is securely included.

In this second embodiment, the lower limit value of the preset range is set as the control start value so that an optimal focus offset value is securely included.

The controller 18 outputs a focus offset control signal to the DSP 21 in accordance with the focus offset value set to the control start value (initial value). The DSP 21 adds focus offset corresponding to the focus offset control signal from the controller 18, and drives the focus drive mechanism 23 to control a focus.

The signal processor 14 generates an equalization error signal with respect to the RF signal output from the RF amplifier 13 using the equalization error generator circuit, and then, outputs it to the controller 18. The controller 18 associates an equalization error value indicating the equalization error signal from the signal processor 14 with the preset focus offset value at that time, and then, records it to the memory 19 (equalization error list 19a) (step B2).

The controller 18 updates the initial focus offset value set in step B1 by predetermined offset (step B3). As described above, the control start value of the focus offset value is set to the lower limit value of the preset range so that an optimal focus offset value is securely included. Thus, the controller 18 updates the focus offset value by predetermined offset in the direction of increasing the value.

In this case, the controller 18 determines whether or not an update count of the focus offset value reaches a predetermined count (step B4). In other words, the controller 18 updates the focus offset value by predetermined offset from the lower limit value to the upper limit value in the preset range including an optimal focus offset value. Then, the controller 18 determines whether or not an equalization error value corresponding to each focus offset value is detected.

If the predetermined count of updates is not completed (NO in step B4), the controller 18 associates an equalization error value indicating the equalization error signal from the signal processor 14 with the preset focus offset value at that time. Then, the controller 18 records the foregoing correspondence to the memory 19 (equalization error list 19a) (step B2).

Likewise, the controller 18 updates the focus offset value by predetermined offset until the update count of the focus offset value reaches a predetermined count. The controller 18 associates an equalization error value indicating the equalization error signal output from the signal processor 14 given with the preset focus offset value when focus is controlled using each focus offset value. Thereafter, the controller 18 records the foregoing correspondence to the equalization error list 19a (steps B2 to B4).

If the predetermined count of update is completed (YES in step B4), the controller 18 selects the minimum equalization error value from the equalization error list 19a. Then, the controller 18 sets the focus offset value corresponding to the selected equalization error value as a focus offset value used for focus control (step B5). Thus, the controller 18 ends the focus offset control procedure.

The controller 18 outputs a focus offset control signal corresponding to the focus offset value set via the focus offset control procedure to the DSP 21 to control focus with respect to the PUH 11.

According to the second embodiment, the optical disk drive stepwise changes the focus offset value by a predetermined value and by a predetermined count. The drive records the equalization error value detected from each focus offset value to the equalization error list 19a. Then, the drive selects a focus offset value corresponding to the most preferable (minimum) equalization error value from all equalization error values. According to the focus offset control procedure of the second embodiment, the focus offset value is updated by a predetermined count; therefore, the procedure is always completed in the same time.

In the second embodiment, the focus offset value is increased by a predetermined offset. In this case, the focus offset value may be updated in the direction of decreasing it by a predetermined offset.

### Third Embodiment

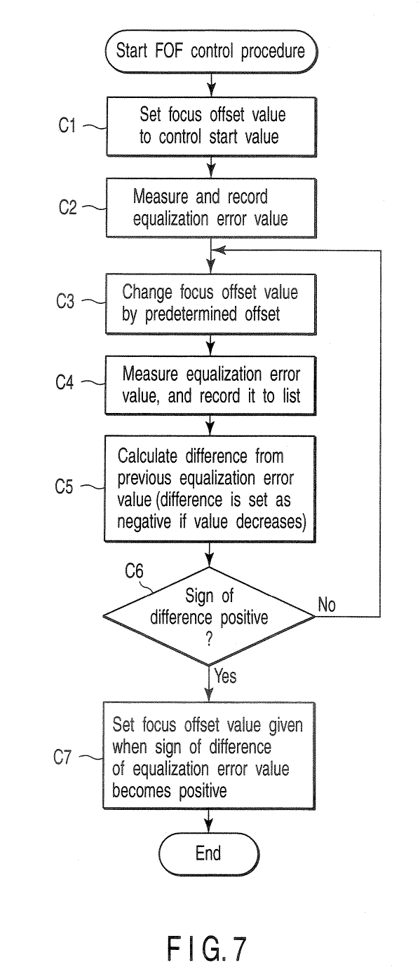

A focus offset (FOF) control procedure according to a third embodiment will be explained below with reference to a flowchart shown in FIG. 7.

The focus offset control procedure of the third embodiment is taken via the following steps. Specifically, a focus offset value is changed from the initial value by a predetermined offset and by a predetermined count to detect an equalization error value. A focus offset value when a change of the equalization error value worsens is set.

Steps C1 to C3 shown in the flowchart of FIG. 7 takes the same procedure as steps B1 to B3 shown in the flowchart of FIG. 7 described in the second embodiment; therefore, the explanation is omitted.

When updating a focus offset value (step C3), the controller 18 associates an equalization error value indicating an equalization error signal output from the signal processor 14 with the focus offset value. Then, the controller 18 records the equalization error value to the memory 19 (equalization error list 19a) (step C4).

When recording the equalization error value to the equalization error list 19a, the controller 18 calculates the difference between the foregoing value and a previous equalization error value recorded to the equalization error list 19a (step C5). As a result, if the equalization error value decreases, a sign of the difference of the equalization error value is set to negative (minus).

The controller 18 determines whether or not the sign of the difference is positive (plus). If the sign of the difference is not positive (NO in step C6), the controller 18 returns to step C3. Then, the controller 18 updates the focus offset value by a predetermined offset (step C3), and takes the same procedure as described above (steps C4 to C6). In other words, if the equalization error value decreases with update on the focus offset value. This means that the focus offset value is updated to close to an optimal focus offset value. Therefore, the controller 18 continuously executes the same procedures.

On the contrary, if the sign of the difference is positive (YES in step C6), the equalization error value increases with update on the focus offset value. In other words, this means that the focus offset value is updated by a predetermined offset, and thereby, exceeds an optimal focus offset value.

The controller 18 sets the focus offset value when the sign of the difference becomes positive as a focus offset value used for focus control (step C7). Thus, the controller 18 ends the focus offset control procedure.

The controller 18 outputs a focus offset control signal corresponding to the focus offset value set via the focus offset control procedure to the DSP 21 to control focus with respect to the PUH 11.

According to the focus offset control procedure of the third embodiment, the focus offset value is updated, and thereby, if the equalization error value worsens (increases), the controller 18 ends the procedure, and sets the foregoing focus offset value. By doing so, processing time is shortened.

If the focus offset value is updated in the direction of increasing the equalization error value from the beginning, it is determined that the sign of the difference of the equalization error value is positive. In this case, the update direction with respect to the focus offset value is inverted, and thereafter, the focus offset control procedure is again taken.

Incidentally, it is more effective to obtain the control start value of the focus offset value closer to an optimal focus offset value. Thus, this serves to provide a high possibility of shortening the processing time.

### Fourth Embodiment

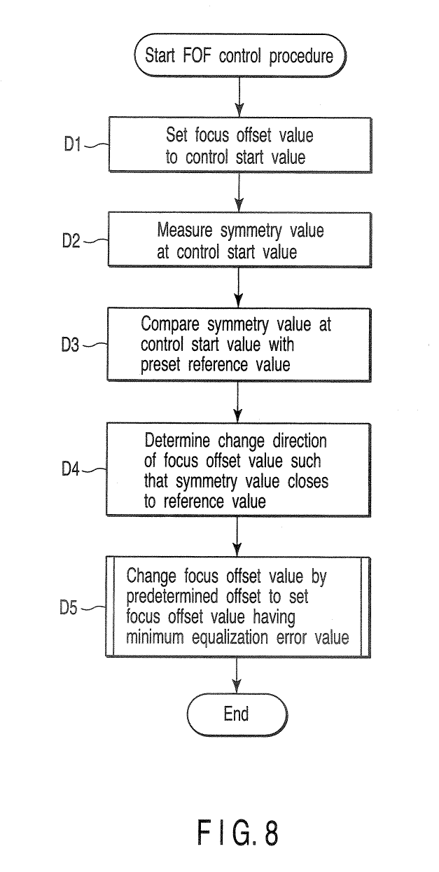

A focus offset (FOF) control procedure according to a third embodiment will be explained below with reference to a flowchart shown in FIG. 8.

The focus offset control procedure of the fourth is embodiment is taken via the following steps. Specifically, a change direction (increase or decrease) of updating a focus offset value is determined using a symmetry value. Then, a focus offset value having the minimum equalization error value is calculated and set while changing the focus offset value according to the foregoing determined direction.

The controller 18 controls a focus offset value to a control start value (initial value) (step D1). According to the fourth embodiment, the control start value (initial value) of the focus offset value is optionally settable every when a focus offset control procedure is taken.

The controller 18 outputs a focus offset signal to the DSP 21 in accordance with the focus offset value controlled to the control start value (initial value). The DSP 21 adds focus offset corresponding to the focus offset control signal from the controller 18, and then, drive the focus drive mechanism 23 to control focus.

The symmetry detector 17 detects a symmetry value with respect to an RF signal output from the RF amplifier 13, and thereafter, outputs it to the controller (step D2). In this case, a symmetry value having 3T or more is used.

The controller 18 compares the symmetry value detected when the focus offset value is set to the control start value with a preset reference value. Then, the controller 18 determines which of the symmetry value or the reference value is larger. In this case, the preset reference value indicates an estimated symmetry value detected when an optimal focus offset value is given.

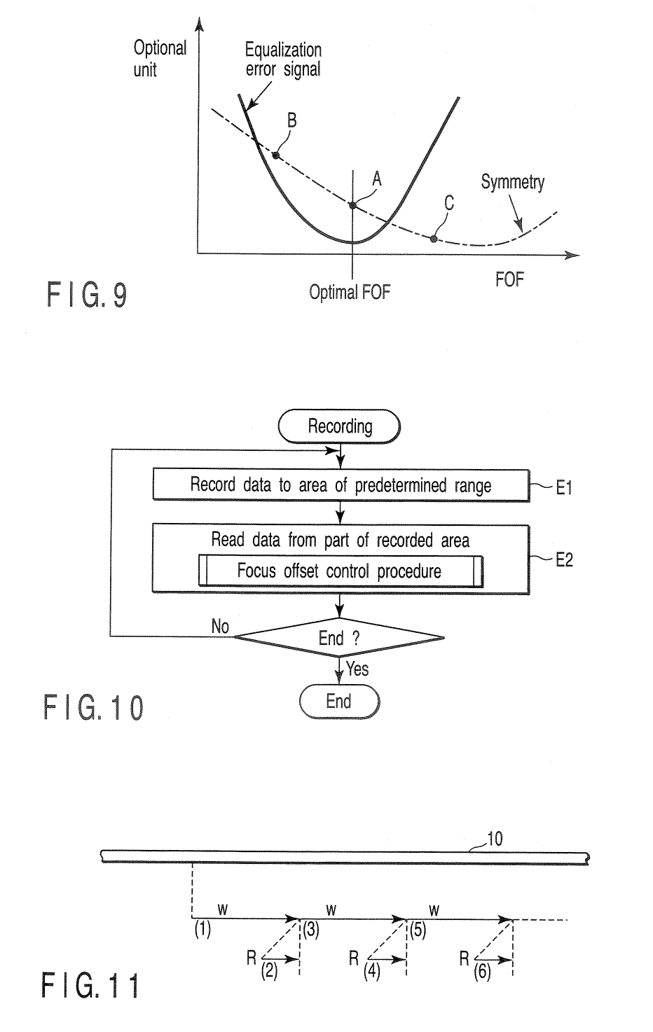

FIG. 9 shows the relationship between an equalization error value with respect o the focus offset value and symmetry. In FIG. 9, a point A on a symmetry curve is set as a reference value.

The controller 18 compares a symmetry value at the control start value with the reference value. As a result, the controller 18 determines that the symmetry value at the control start value is larger than the reference value. In this case, the controller 18 sets update in the direction of increasing the focus offset value in order to close the symmetry value to the reference value.

For example, as shown in FIG. 9, if a focus offset value corresponding to a point B on the symmetry curve is set as the control start value, the symmetry value at the point B is larger than the symmetry value (reference value) at the point A. In this case, the focus offset value is updated in the direction increasing from the control start value. By doing so, the focus offset value is closed to an optimal focus offset value.

Conversely, as depicted in FIG. 9, if a focus offset value corresponding to a point C on the symmetry curve is set as the control start value, the symmetry value at the point C is smaller than the symmetry value (reference value) at the point A. In this case, the focus offset value is updated in the direction decreasing from the control start value. By doing so, the focus offset value is closed to an optimal focus offset value.

The controller 18 compares the symmetry value at the control start value with the reference value, thereby determining the direction (increase or decrease) of changing the focus offset value. Then, the controller 18 updates the focus offset value in the foregoing determined direction to set an optimal focus offset value based on an equalization error value (step D5). The step D5 is taken in the same manner as the focus offset control procedures described in the second and third embodiments; therefore, the details are omitted.

The use of equalization error value only evaluates whether or not the focus offset value is preferably set. On the contrary, the symmetry value is used, and thereby, it is possible to determine the update direction (increase or decrease) capable of closing the focus offset value to the optimal focus offset value.

The symmetry value is used, and thereby, the direction of updating the focus offset value is simply determined. Therefore, even if the control start value (initial value) of the focus offset value is optionally set, the focus offset control procedure is speedily taken.

FIG. 10 is a flowchart to explain a recording procedure using the focus offset control procedure.

According to the recording procedure shown in FIG. 10, the following steps are taken. Specifically, as shown in FIG. 11, data is recorded to a predetermined area of the optical disk 10 (step E1) (FIG. 11 (1)). Then, data is read from part of the recorded area (step D2) (FIG. 11 (2)). Based on the result of reading the recorded area, recording control with respect to the next predetermined area (e.g., recording power control, storage change, etc.) is carried out.

According to the foregoing recording procedure, when the recorded area is read (FIG. 11, (2) (4) (6) . . . ), the focus offset control procedure is taken to control focus. By doing so, data is readable in an optimal focus.

In general, a symmetry check is made when data is recorded to the optical disk 10. Therefore, the foregoing focus offset control procedure is taken for a short time using the symmetry value detected for the symmetry check. This serves to shorten the processing time in the recording procedure of repeating data record and read shown in FIG. 11.

### Fifth Embodiment

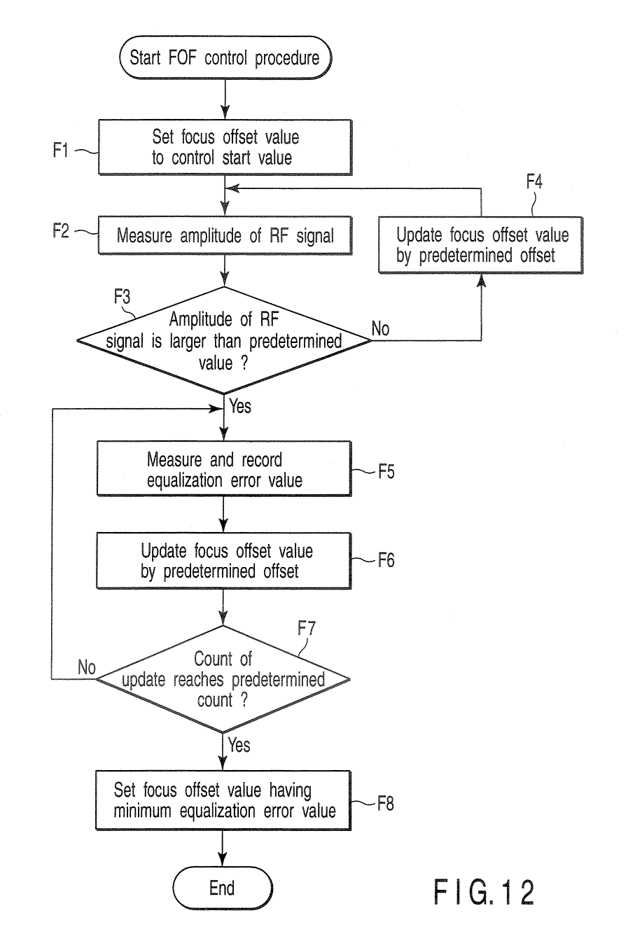

A focus offset (FOF) control procedure according to a fifth embodiment will be explained below with reference to a flowchart shown in FIG. 12.

The focus offset control procedure of the fifth embodiment is taken via the following steps. Specifically, a focus offset value is changed by predetermined offset in a range where the amplitude of a RF signal becomes larger than a predetermined value to set the minimum focus offset value.

First, the controller 18 controls a focus offset value to a control start value (initial value) (step F1).

The controller 18 outputs a focus offset signal to the DSP 21 in accordance with the focus offset value controlled to the control start value (initial value). The DSP 21 adds focus offset corresponding to the focus offset control signal from the controller 18, and then, drive the focus drive mechanism 23 to control focus.

The amplitude measuring unit 16 measures the amplitude of a RF signal output from the RF amplifier 13, and then, outputs it to the controller 18 (step F2).

The controller 18 determines whether or not the amplitude of the RF signal measured by the amplitude measuring unit 16 is larger than a predetermined value. If the amplitude of the RF signal measured is larger than the predetermined value (NO in step F3), the controller 18 updates the focus offset value by predetermined offset. In this case, the method of the fourth embodiment may be used to determine whether update should be made in any of the direction of increasing or decreasing the focus offset value.

The predetermined offset updating the focus offset value is different from that of step F6 described later. For example, the predetermined offset is set larger than a predetermined offset value used in step F6. In other words, this step F3 is a procedure to determine whether or not an equalization error value is stably output according to the amplitude of the RF signal. Therefore, there is no need of high accurate control spending long processing time.

Likewise, the controller 18 updates the focus offset value until the amplitude of the RF signal measured by the amplitude measuring unit 16 becomes larger than the predetermined value. If the amplitude of the RF signal measured by the amplitude measuring unit 16 is larger than a predetermined value (YES in step F3), the controller 18 takes the following procedure. Specifically, the controller 18 associates an equalization error value indicating an equalization error signal output from the signal processor 14 with the focus offset value. Then, the controller 18 records the equalization error value to the memory 19 (equalization error list 19a) (step F5).

Steps F5 to F8 are the same as steps B2 to B5 of the flowchart shown in FIG. 6 described in the second embodiment; therefore, the detailed explanation is omitted.

According to the focus offset control procedure of the fifth embodiment, the amplitude of the RF signal becomes larger than the predetermined value, and then, a state that the equalization error value is correctly obtained is given. Thereafter, the focus offset value is controlled based on the equalization error value. By doing so, an optimal focus offset value is obtained using effective range only as a target; therefore, wasteful processing time is reduced.

In the fifth embodiment, it is possible to take the procedure using the symmetry described in the fourth embodiment.

If it is determined in step F7 that a predetermined count of updates is completed, update on the focus offset value ends. The following procedure may be taken. Specifically, by update on the focus offset value, if the amplitude of the RF signal measured by the amplitude measuring unit 16 becomes lower than the predetermined value, update on the focus offset value ends.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An optical disk drive comprising:
an optical pickup which emits a light beam onto an optical disk, and receiving a reflection light to output a signal in accordance with the reflection light;
a PRML processing unit which carries out signal processing with respect to the signal output from the optical pickup using a partial response and maximum likelihood (PRML) technique;
a focus offset setting unit which sets a focus offset value used for focusing the optical pickup based on a difference value between a signal processed by the PRML processing unit and the signal output from the optical pickup; and
a focus control unit which controls a focus of the optical pickup in accordance with focus offset set by the focus offset setting unit.

2. The drive according to claim 1, wherein the focus offset setting unit includes:
a setting unit which sets a focus offset value to a predetermined value;
a focus value update unit which updates the focus offset value set by the setting unit by predetermined offset in any direction of increase or decrease;
a recording unit which records each difference value detected when focus is controlled according to each focus offset value updated by the focus value update unit;
a update direction inverting unit which inverts the direction of updating the focus offset value by the focus value update unit when the difference value recorded by the recording unit increases with update on focus value by the focus value update unit; and
a focus offset value selecting unit which selects a focus offset value used for focusing based on the difference value recorded by the recording unit.

3. The drive according to claim 1, wherein the focus offset setting unit includes:
a setting unit which sets a focus offset value to a control start value;
a focus value update unit which updates the focus offset value set controlled to the control start value by the setting unit by predetermined offset and by a predetermined count;
a recording unit which records each difference value detected when focus is controlled according to each focus offset value updated by the focus value update unit; and
a focus offset value selecting unit, selects a focus offset value used for focusing based on the difference value recorded by the recording unit.

4. The drive according to claim 1, wherein the focus offset setting unit includes:
a setting unit which sets a focus offset value to a control start value;
a focus value update unit which updates the focus offset value set controlled to the control start value by the setting unit by predetermined offset;
a recording unit which records each difference value detected by when focus is controlled according to each focus offset value updated by the focus value update unit; and
a focus offset value selecting unit which selects the focus offset value updated by the focus value update unit as a focus offset value used for focusing when the difference value recorded by the recording unit increases with update on focus value by the focus value update unit.

5. The drive according to claim 1, further comprising:
a recording power value detecting unit which detects a recording power characteristic based on a signal output from the optical pickup,
the focus offset setting unit including:
a setting unit which sets a focus offset value to a control start value;
a recording power value characteristic comparing unit which compares a recording power characteristic detected by the recording power value detecting unit when focus is controlled according to the focus offset value set by the setting unit with a preset reference value;
a focus value update unit which updates the focus offset value set by the setting unit by predetermined offset in any direction of increase or decrease based on the comparative result by the comparing unit;
a recording unit which records each difference value detected when focus is controlled according to each focus offset value updated by the focus value update unit; and
a focus offset value selecting unit which selects a focus offset value used for focusing based on the difference value recorded by the recording unit.

6. The drive according to claim 1, further comprising:
an amplitude measuring unit which measures an amplitude of a signal output from the optical pickup;
the focus offset setting unit including:
a setting unit which sets a focus offset value to a control start value;
an amplitude comparing unit which compares an amplitude measured by the amplitude measuring unit when focus is controlled according to the focus offset value set by the setting unit with a preset reference value;
a focus value update unit which updates the focus offset value set to the control start value by the setting unit by predetermined offset and by a predetermined count when it is determined that the amplitude measured by the amplitude measuring unit is larger than the reference value;
a recording unit which records each difference value detected when focus is controlled according to each focus offset value updated by the focus value update unit; and
a focus offset value selecting unit which selects a focus offset value used for focusing based on the difference value recorded by the recording unit.

7. An optical disk drive comprising:
an optical pickup which emits a light beam onto an optical disk, and receiving a reflection light to output a signal in accordance with the reflection light;
an equalizing unit which equalizes a waveform of a signal output from the optical pickup;
a PRML processing unit which carries out signal processing with respect to the signal equalized by the equalizing unit using a partial response and maximum likelihood (PRML) technique;
an ideal waveform generating unit which generates a signal having an ideal waveform based on the signal processed by the PRML processing unit;
a difference detecting unit which detects a difference value between the signal generated by the ideal waveform generating unit and the signal waveform-equalized by the equalizing unit;
a focus offset setting unit which sets a focus offset value used for focusing the optical pickup based on the difference value detected by the difference detecting unit; and
a focus control unit which controls focus of the optical pickup in accordance with focus offset set by the focus offset setting unit.

8. The drive according to claim 7, further comprising:
an absolute average detecting unit which detects an absolute average of the difference value detected by the difference detecting unit,
the focus offset setting unit setting a focus offset value based on the absolute average detected by the absolute average detecting unit.

9. The drive according to claim 7, wherein the focus offset setting unit includes:
a setting unit which sets a focus offset value to a predetermined value;
a focus value update unit which updates the focus offset value set by the setting unit by predetermined offset in any direction of increase or decrease;
a recording unit which records each difference value detected by the difference detecting unit when focus is controlled according to each focus offset value updated by the focus value update unit;
a update direction inverting unit which inverts the direction of updating the focus offset value by the focus value update unit when the difference value recorded by the recording unit increases with update on a focus value by the focus value update unit; and
a focus offset value selecting unit which selects a focus offset value used for focusing based on the difference value recorded by the recording unit.

10. The drive according to claim 7, wherein the focus offset setting unit includes:
a setting unit which sets a focus offset value to a control start value;
a focus value update unit which updates the focus offset value set controlled to the control start value by the setting unit by predetermined offset;
a recording unit which records each difference value detected by the difference detecting unit when focus is controlled according to each focus offset value updated by the focus value update unit; and
a focus offset value selecting unit, selects a focus offset value used for focusing based on the difference value recorded by the recording unit.

11. The drive according to claim 7, wherein the focus offset setting unit includes:
a setting unit which sets a focus offset value to a control start value;
a focus value update unit which updates the focus offset value set controlled to the control start value by the setting unit by predetermined offset;
a recording unit which records each difference value detected by the difference detecting unit when focus is controlled according to each focus offset value updated by the focus value update unit; and
a focus offset value selecting unit which selects the focus offset value updated by the focus value update unit as a focus offset value used for focusing when the difference value recorded by the recording unit increases with update on focus value by the focus value update unit.

12. The drive according to claim 7, further comprising:
a recording power value detecting unit which detects a recording power characteristic based on a signal output from the optical pickup,
the focus offset setting unit including:
a setting unit which sets a focus offset value to a control start value;
a recording power value characteristic comparing unit which compares a recording power characteristic detected by the recording power value detecting unit when focus is controlled according to the focus offset value set by the setting unit with a preset reference value;
a focus value update unit which updates the focus offset value set by the setting unit by predetermined offset in any direction of increase or decrease;
a recording unit which records each difference value detected by the difference detecting unit when focus is controlled according to each focus offset value updated by the focus value update unit; and
a focus offset value selecting unit which selects a focus offset value used for focusing based on the difference value recorded by the recording unit.

13. The drive according to claim 7, further comprising:
an amplitude measuring unit which measures an amplitude of a signal output from the optical pickup;
the focus offset setting unit including:
a setting unit which sets a focus offset value to a control start value;
an amplitude comparing unit which compares an amplitude measured by the amplitude measuring unit when focus is controlled according to the focus offset value set by the setting unit with a preset reference value;
a focus value update unit which updates the focus offset value set to the control start value by the setting unit by predetermined offset and by a predetermined count when it is determined that the amplitude measured by the amplitude measuring unit is larger than the reference value;
a recording unit which records each difference value detected by the difference detecting unit when focus is controlled according to each focus offset value updated by the focus value update unit; and
a focus offset value selecting unit which selects a focus offset value used for focusing based on the difference value recorded by the recording unit.

14. A focus offset control method of controlling a focus of an optical pickup with respect to an optical disk, comprising:
carrying out signal processing with respect to the signal output from the optical pickup using a PRML technique;
setting a focus offset value used for focusing the optical pickup based on a difference value between a signal processed by the PRML processing unit and the signal output from the optical pickup; and
controlling a focus of the optical pickup in accordance with focus offset set by the focus offset setting unit.

15. A focus offset control method of controlling a focus of an optical pickup with respect to an optical disk, comprising:
equalizing a waveform of a signal output from the optical pickup;
carrying out signal processing with respect to the equalized signal using a PRML technique;
generating a signal having an ideal waveform based on the processed signal;
detecting a difference value between the generated signal and the equalized signal;
setting a focus offset value used for focusing the optical pickup based on the detected difference value; and
controlling a focus of the optical pickup in accordance with the set focus offset.

16. The method according to claim 15, wherein setting the focus offset includes:
setting a focus offset value to a predetermined value;
updating the set focus offset value by predetermined offset in any direction of increase or decrease;
recording each detected difference value when focus is controlled according to each updated focus offset value;
inverting the direction of updating the focus offset value by the focus value update unit when the recorded difference value increases with update on a focus value; and
selecting a focus offset value used for focusing based on the recorded difference value.

17. The method according to claim 15, wherein setting the focus offset includes:
setting a focus offset value to a control start value;
updating the focus offset value set controlled to the control start value by predetermined offset;
recording each detected difference value when focus is controlled according to each updated focus offset value; and
a focus offset value selecting unit, selects a focus offset value used for focusing based on the recorded difference value.

18. The method according to claim 15, wherein setting the focus offset includes:
setting a focus offset value to a control start value;
updating the focus offset value set controlled to the control start value by predetermined offset;
recording each detected difference value when focus is controlled according to each updated focus offset value; and
selecting the updated focus offset value by the focus value as a focus offset value used for focusing when the recorded difference value increases with update on a focus value.

19. The method according to claim 15, wherein setting the focus offset includes:
setting a focus offset value to a control start value;
detecting a recording power characteristic based on a signal output from the optical pickup when focus is controlled according to the set focus offset value;
comparing the detected recording power characteristic with a preset reference value;
updating the set focus offset value by predetermined offset in any direction of increase or decrease based on the comparative result;
recording each detected difference value when focus is controlled according to each updated focus offset value; and
selecting a focus offset value used for focusing based on the recorded difference value.

20. The method according to claim 15, wherein setting the focus offset includes:
setting a focus offset value to a control start value;
measuring an amplitude of a signal output from the optical pickup when focus is controlled according to the set focus offset value;
comparing the measured amplitude with a preset reference value;
updating the focus offset value set to the control start value by predetermined offset and by a predetermined count when it is determined that the measured amplitude is larger than the reference value;
recording each detected difference value when focus is controlled according to each updated focus offset value; and
selecting a focus offset value used for focusing based on the recorded difference value.
